(19) United States
(12) Patent Application Publication
(10) Pub. No.: US 2005/0001736 A1
(43) Pub. Date: Jan. 6, 2005

(54) Clamp to retain an electrical transmission line in a passageway

(76) Inventors: David R. Hall, Provo, UT (US); H. Tracy Hall JR., Provo, UT (US); David Pixton, Lehi, UT (US); Scott Dahlgren, Provo, UT (US); Cameron Sneddon, Provo, UT (US); Michael Briscoe, Lehi, UT (US); Joe Fox, Spanish Fork, UT (US)

Correspondence Address: Cameron Sneddon, 2185 S. Larsen Pkwy., Provo, UT, 84606, US

(21) Appl. No.: 10/613,550

(22) Filed: Jul. 2, 2003

(51) Int. Cl. G01V 3/00

(52) U.S. Cl. 340/854.1; 340/855.1

(57) ABSTRACT

The invention is a clamp for retaining an electrical transmission line within a passageway. The clamp is comprised of multiple elements including a loading body and an elongated looking body which together retain the electrical transmission line in box end and pin end tool joint. In one embodiment of the invention it is a system for retaining an electrical transmission line within downhole components. The invention allows a transmission line to be attached to the internal diameter of drilling components. In accordance with one aspect of the invention, the system includes a plurality of downhole components, such as sections of pipe in a drill string, drill collars, heavy weight drill pipe, and jars. The system also includes a coaxial cable running between the first and second end of a drill pipe, the coaxial cable having a conductive tube and a conductive core within it. The invention allows the electrical transmission line to withstand the tension and compression of drill pipe during routine drilling cycles.

### BACKGROUND

The present invention relates to the field of retention mechanisms of electrical transmission lines, particularly retention mechanisms for coaxial cables. The preferred mechanisms are particularly well suited for use in difficult environments wherein it is desirable to retain a transmission line without the normal means available such as brackets and such. One such application is in data transmission systems for downhole environments, such as along a drill string used in oil and gas exploration or along the casings and other equipment used in oil and gas production.

The goal of accessing data from a drill string has been expressed for more than half a century. As exploration and drilling technology has improved, this goal has become more important in the industry for successful oil, gas, and geothermal well exploration and production. For example, to take advantage of the several advances in the design of various tools and techniques for oil and gas exploration, it would be beneficial to have real time data such as temperature, pressure, inclination, salinity, etc. Several attempts have been made to devise a successful system for accessing such drill string data. One such system is disclosed in co-pending U.S. application Ser. No. 09/909,469 (also published as PCT Application WO 02/06716) which is assigned to the same assignee as the present invention. The disclosure of this U.S. application Ser. No. 09/909,469 is incorporated herein by reference. Another such system is disclosed in co-pending U.S. application Ser. No. ______ the title of which is DATA TRANSMISSON SYSTEM FOR A DOWNHOLE COMPONENT file on Feb. 3, 2003. The disclosure of this U.S. application Ser. No. ______ is herein incorporated by reference.

### SUMMARY

Briefly stated, the invention is a clamp used to retain an electrical transmission line within a passageway. Another aspect of the invention is a system for retaining an electrical transmission line through a string of downhole components.

In accordance with one aspect of the invention, the system includes a plurality of downhole components, such as sections of pipe in a drill string. Each component has a first and second end, with a first communication element located at the first end and a second communication element located at the second end. Each communication element includes a first contact and a second contact. The system also includes a coaxial cable running between the first and second communication elements, the coaxial cable having a conductive tube and a conductive core within it. The system also includes a first and second connector for connecting the first and second communication elements respectively to the coaxial cable. Each connector includes a conductive sleeve, lying concentrically within the conductive tube, which fits around and makes electrical contact with the conductive core. The conductive sleeve is electrically isolated from the conductive tube. The conductive sleeve of the first connector is in electrical contact with the first contact of the first communication element, the conductive sleeve of the second connector is in electrical contact with the first contact of the second communication element, and the conductive tube is in electrical contact with both the second contact of the first communication element and the second contact of the second communication element.

In accordance with another aspect of the invention, the drill components are sections of drill pipe, each having a central bore, and the first and second communication elements are located in a first and second recess respectively at each end of the drill pipe. The system further includes a first passage passing between the first recess and the central bore and a second passage passing between the second recess and the central bore. The first and second connectors are located in the first and second passages respectively. Preferably, each section of drill pipe has a portion with an increased wall thickness at both the box end and the pin end with a resultant smaller diameter of the central bore at the box end and pin end, and the first and second passages run through the portions with an increased wall thickness and generally parallel to the longitudinal axis of the drill pipe. The box end and pin end is also sometimes referred to as the box end tool joint and pin end tool joint. The system further includes a first and second cross port in each box end tool joint and pin end tool joint in communication with the first and second passages. Preferably the cross port is cylindrical in shape and includes a means of engaging a loading body as the one described below.

In accordance with another aspect of the invention, the components are sections of drill pipe, drill collars, jars, and similar components that would be typically found in a drill string. This invention is particularly useful when such drill components have a substantially uniform internal diameter.

In accordance with another aspect of the invention, the system includes a first and second elongate looking body, each of which includes a portion adapted to engage the conductive tube of the coaxial cable. The portion adapted to engage the conductive tube can be a slot. In a preferable embodiment of the invention, the slot will have ridges on its surface forming teeth that dig into the conductive tube as a means of retaining the coaxial cable. The system also preferably includes a first and second loading body, each of which includes on its outer surface a means for engaging the cross ports in the box end and pin end tool joints, thus the loading body compressively loads the elongate looking body and holds it in place.

In accordance with another aspect of the invention, the method includes affixing the conductive tube to the inside diameter of the drill component.

In accordance with another aspect of the invention, the method includes machining a cross port on the outside of each box and pin end tool joint. The cross port connects to or communicates with each passageway in the box and pin end tool joint and is shaped to contain and receive a clamp including an elongate looking body and a loading body. The method also includes placing a coaxial cable in the central bore of drill pipe sections including the first and second passageways connecting the first and second recess to the central bore of the dill pipe. A first and second elongate looking body is placed in the first and second cross port. The end of the elongate looking body adapted to engage the conductive tube of the coaxial cable is placed on top of the conductive tube. A first and second loading body is placed on top of the elongate looking body and made to engage the cross port, thereby forcefully retaining the elongate looking body and thus the conductive tube, in compressive load. The method further includes inserting a water-tight seal between the wall of cross port and the outer portion of the elongate looking body.

The present invention, together with attendant objects and advantages, will be best understood with reference to the detailed description below in connection with the attached drawings.

### BRIEF DESCRIPTION OF THE DRAWINGS

FIG. 1 is perspective view of an elongate looking body used in the present invention.

FIG. 2 is a side view of an elongate looking body exhibiting some features of the current invention.

FIG. 3 is a perspective view from the top of a loading body used in the present invention.

FIG. 4 is a perspective view from the bottom of the loading body showing a generally flat surface.

FIG. 5 is a perspective view from the bottom of the loading body showing a concave surface.

FIG. 6 is a cross-section of a pin end tool joint of a drill component showing a cross port and the passageway between the drill component tool joint and the central bore of the component.

FIG. 7 is a cross-section of a box end tool joint of a drill component showing a cross port and a passageway between the drill component tool joint and the central bore of the component.

FIG. 8 is a cross-section of a pin end tool joint of a drill component showing a clamp and a coaxial cable in the cross port and passageway respectively.

FIG. 9 is a cross-section of a box end tool joint of a drill component showing a clamp and a coaxial cable in the cross port and passageway respectively.

FIG. 10 is an enlarged cross-sectional view of a cross port in communication with the passageway in either box or pin end tool joint.

FIG. 11 is an enlarged cross-sectional view of a cross port with all the components of the clamp shown.

### DETAILED DESCRIPTION OF THE PRESENTLY PREFERRED EMBODIMENTS

It should be noted that, as used herein, the term “downhole” is intended to have a relatively broad meaning, including such environments as drilling in oil and gas, and geothermal exploration, the systems of casings and other equipment used in oil, gas and geothermal production.

It should also be noted that the term “transmission” as used in connection with the phrase data transmission or the like, is intended to have a relatively broad meaning, referring to the passage of signals in at least one direction from one point to another.

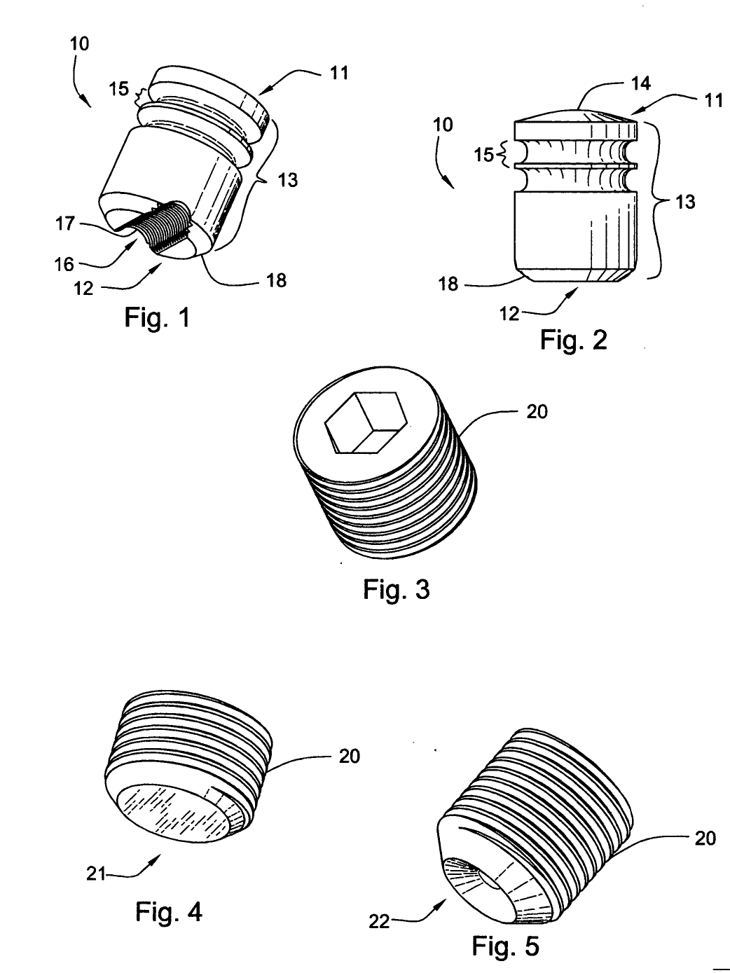

Referring to the drawings, FIG. 1 is a perspective view of an elongate body used in the present clamp invention. The most preferred application of the clamp is in the data transmission system in sections of drill pipe, which make up a drill string used in oil and gas or geothermal exploration.

The depicted elongate looking body 10 of FIG. 1 includes a first end 12, a second end 11, and an outer portion 13. The first end 12 is adapted to engage an electrical transmission line, one such example is a coaxial cable. The modified first end adapted to engage such a transmission line can be a slot 16. Furthermore, in the preferred embodiment of the invention, a ridged surface 17 along the slot 16 will employ teeth to dig into the conductive tube of a coaxial cable to enhance the clamps engagement force. The teeth dig in only a few millimeters, not enough to distort the signal passing through the coaxial cable, but sufficient to better retain the conduit within the drill component. Most preferably, the ridges run perpendicular to the movement of the coaxial cable within a drill component.

The outer portion 13 of elongate looking body 10 is contained within the cross port. The elongate looking body is made such that the length of the body is greater than its width. This feature enables one to assemble the clamp without the elongate looking body turning to one side thus keeping the slot 16 in line with the coaxial cable. It will also include grooves adapted to house a means for sealing against the cross port. In one embodiment of the invention, the elongate looking body 10 has a generally cylindrical outer portion 13. The outer portion 13 includes circumferential o-ring grooves 15, most preferably located near the second end 11, wherein rings are used as the means of sealing between the elongate looking body and the cross port wall.

In another embodiment of the invention the first end 12 and the second end 11 have a generally rounded surface. Preferably the first end 12 has a flat surface with a chamfered edge 18. Whereas the second end 11 has a rounded surface 14 as shown in FIG. 2. These features enable the elongate body to better engage the conductive tube and minimize any rotation of the elongate body within the cross port as will be discussed below.

FIG. 2 depicts a side view of the elongate looking body 10, including the first end 12, the second end 11, and the outer portion 13. The o-ring grooves 15 are also shown near the second end 11. Multiple o-ring grooves 15 are shown as the preferred embodiment, though limiting the grooves to one is also acceptable. The elongate looking body 10 as shown in FIG. 2 shows the generally rounded surface 14 on the second end 11. This is the most preferable version of the invention though a flat surface could also suffice. The rounded surface allows less surface contact to be made with the loading body and thus will help to maintain the position of the elongate body during installation of the loading body. The chamfered edge 18 ensures complete contact between the conductive tube and the slot 16. Without the chamfered edge 18, a straight walled outer portion 13 of first end 12 might engage the surrounding cross port side wall thus limiting the engaging force of the slot 16 on the conductive tube.

The elongate looking body can be composed of various materials such as metals and ceramics. Preferably the elongate looking body is made of metal. Such metals can include steel, titanium, chrome, nickel, aluminum, iron, copper, tin, and lead. More preferably the chosen metal is steel including viscount 44, D2, stainless steel, tool steel, and 4100 series steels. Most preferably the chosen steel is D2. The elongate looking body preferably has a hardness of at least 30 on a Rockwell C hardness scale.

In another embodiment of the invention the material used to make the elongate looking body is a ceramic. Some possible ceramics are cemented tungsten carbide, alumina, silicon carbide, silicone nitride, and polycrystalline diamond.

The following figures depict various loading body designs. FIG. 3 is a perspective view from the top of a typical loading body 20. Most preferably the loading body is generally cylindrical. This particular embodiment is a modified set screw. Other types of loading body designs can include a tapered edge including barbs. The loading body is contained within the cross port. A cross port could also have a tapered side wall generally matching the taper of the loading body 20. Insertion of a barbed tapered loading body into such a cross port would cause the barbed surface of the loading body to engage in the tapered side wall of the cross port Once inserted, the removal of the loading body would be difficult, thus the preferred embodiment of the loading body 20 is a set screw.

FIG. 4 shows the perspective view from the bottom. A truncated cone 21 on the first end is preferred to engage the rounded surface 14 of the second end 11 of elongate body 10. This results in a minimal surface area contact which allows the elongate body 10 to not rotate upon insertion of the loading body 20. Another embodiment of the invention includes a concave surface 22 on the first end of the loading body 20 as depicted in FIG. 5.

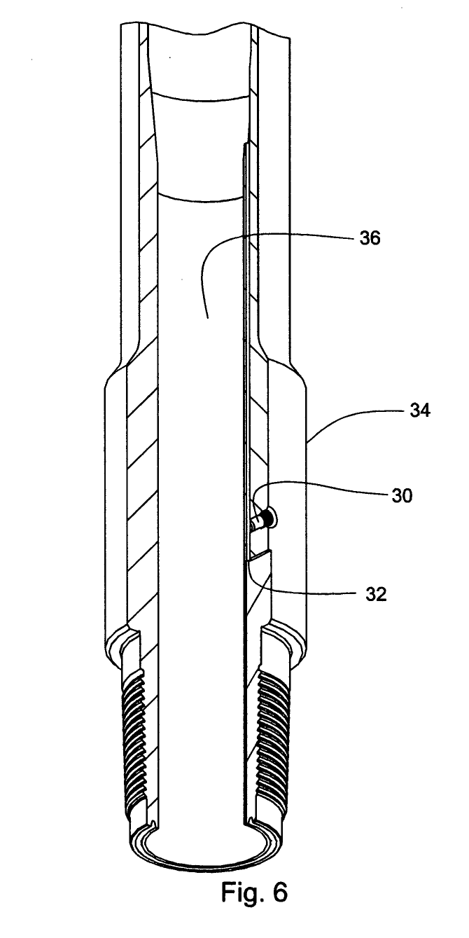

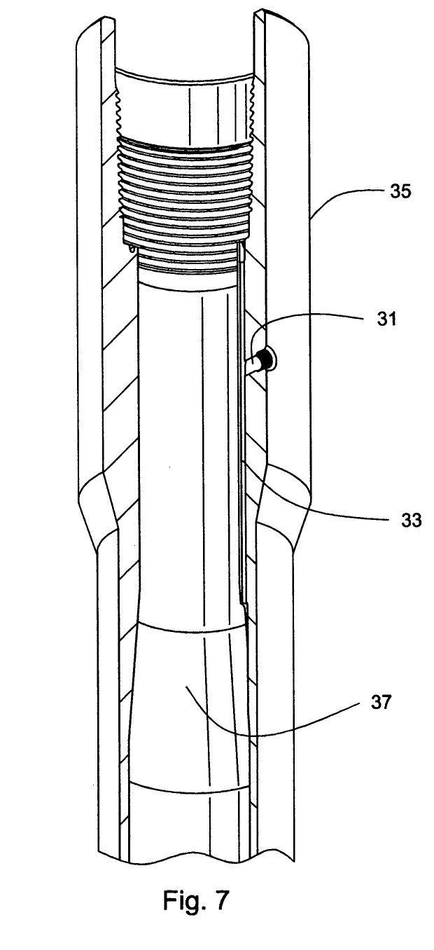

FIG. 6 is a cross sectional view of the pin end portion of a drilling component or in this case a drill pipe. A central bore 36 passes through the drill component or drill pipe. The pin end tool joint 34 includes a first cross port 30 in communication with a first passageway 32. The first passageway 32 is further connected to the central bore 36. FIG. 7 depicts a box end tool joint 35 which also contains the same elements as pin end tool joint 34. A second cross port 31 is in communication with a second passageway 33 located within the box end tool joint 35. The second passageway 33 is connected to a central bore 37. The central bores 36 and 37 are the same bore but denote different ends of the central bore. As will be seen in other drawings, a coaxial cable passes through the central bore with each terminating end of the coaxial cable placed in the first passageway 32 and the second passageway 33. Each terminating end of the coaxial cable is placed beyond the first cross port 30 and the second cross port 31. The passageway is made generally parallel to the longitudinal axis of the drill pipe. An enlarged view of the cross port and coaxial cable will be shown in the figures discussed below.

Between the pin end 34 and box end 35 is the body of the section. A typical length of the body is between 30 and 90 feet. Drill strings in oil and gas production can extend as long as 20,000 feet, which means that as many as 700 sections of drill pipe and downhole tools can be used in the drill string.

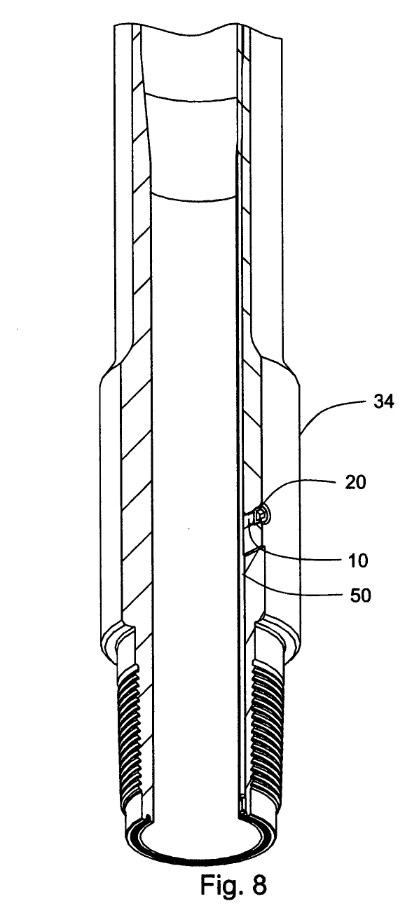

FIG. 8 depicts the same pin end tool joint 34 as shown in FIG. 6. An electrical transmission line or a coaxial cable 50 is located within the first passageway 33. The first elongated body 10 is located in the first cross port 30. A first loading body 20 is located on top of the first elongated body 10. The first loading body 20 and elongated body 10 are contained within the cross port 30.

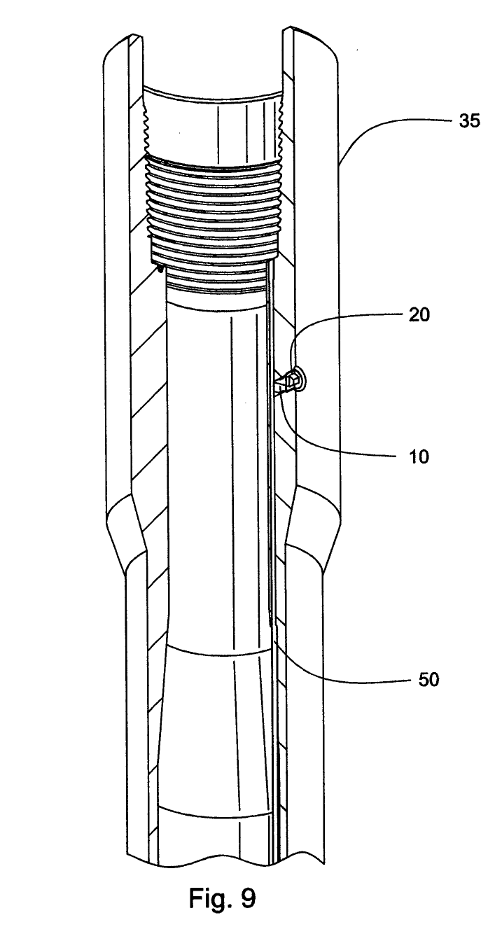

FIG. 9 depicts the same box end tool joint 35 as shown in FIG. 7 and the same clamp elements as shown in FIG. 8. The coaxial cable 50 is placed within the second passageway 33. The coaxial cable 50 is stretched along the central bore 37 to the other end 36. Preferably the cable is stretched between the box end 35 and pin end 34 when it is located within the second passageway 33 and the first passageway 32. The conductive tube of coaxial cable 50 is preferably held in tension after it is inserted in the drill pipe and remains in tension during downhole use. This prevents the conductive tube from moving during downhole use. In a preferred embodiment, the conductive tube is in tension within the drill component as described above, the preferred amount of tension being between 300 and 1200 pounds-force. The elements of the clamp, the elongated body 10 and the loading body 20, are placed in the second cross port 31. The conductive tube has an elasticity enabling it to remain in tension after installation and throughout the life of the conductive tube. A more detailed view of the clamp as located in each box end and pin end tool joint will be discussed with the remaining drawings.

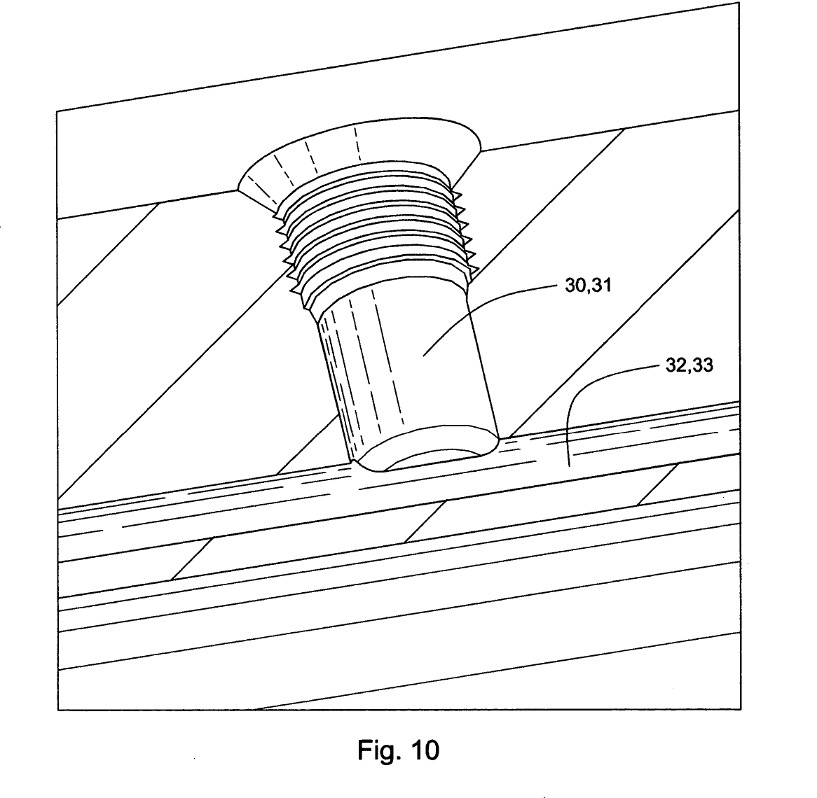

An enlarged perspective cross-sectional view of the cross port is found in FIG. 10. The first and second cross port, 30 and 31, as shown in the previously discussed figures are depicted in FIG. 10. Because the first and second cross ports, 30 and 31, are substantially the same, only one figure representing both will be shown. Thus multiple labels are shown for each first and second element. It is to be understood that each first and second element of the clamp invention however is found in both the box end and pin end tool joint. A first and second passageway, 32 and 33, is shown in the tool joint end of a drill pipe.

The cross port opens to the outside of each box and pin end tool joint. In a preferred embodiment, a chamfer is included at both ends of the cross port as can be seen in FIG. 10. A portion of the cross port is adapted to engage the outer portion of the loading body. As depicted in FIG. 10 and the preferred embodiment, the upper portion of the cross port is threaded to engage the loading body. The portion below the threaded end of the cross port is where the elongated body resides.

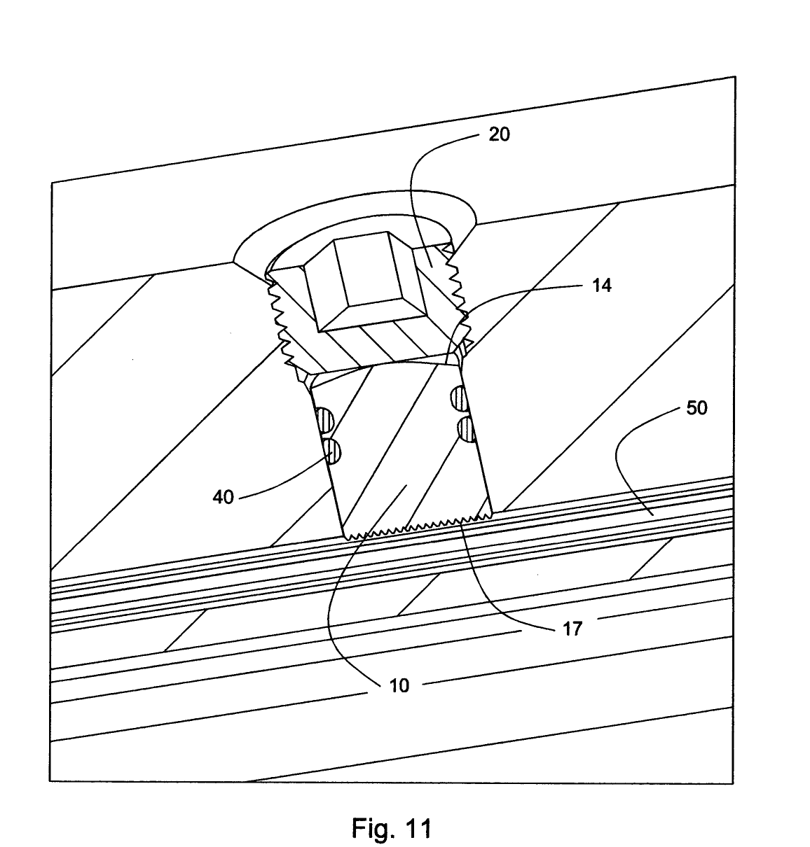

The entire clamp invention with all the elements is depicted in an enlarged perspective cross sectional view as shown FIG. 11. The coaxial cable 50 includes a conductive tube and a conductive core within it. The slot 16 including the ridged surface 17 of elongated part 10 engages the conductive tube of coaxial cable 50. The surface ridges 17 preferable run perpendicular to the length of the conduit. During normal operation of a drill string, the components in the drill string will be in tension and compression at various times during drilling. To further ensure the coaxial cable is retained in the same position during each tensioning and compressioning of a drill component, the perpendicular surface ridges 17 dig into the conductive tube of the coaxial cable 50, thereby forcing the tube to stretch and compress with the drill component. The conductive tube is preferably made of metal, more preferably a strong metal, most preferably steel. By “strong metal” it is meant that the metal is relatively resistant to deformation in its normal use state. The metal is preferably stainless steel, most preferably 316 or 316L stainless steel. A preferred supplier of stainless steel is Plymouth Tube, Salisbury, Md.

In an alternative embodiment, the conductive tube may be insulated from the pipe in order to prevent possible galvanic corrosion. At present, the preferred material with which to insulate the conductive tube 71 is PEEK®.

In the preferred embodiment, a set of o-rings 40 are located in the grooves 15 for a water tight seal between the elongated part 10 and the cross port 30 and 31. The sealing mechanism need not be o-rings but any generally accepted elastomeric or non-elastomeric type of seal known in the sealing art. In a preferred embodiment the elongated looking body 10 will include a generally rounded surface 14 on second end 11. The second end 11 engages the first end of the loading body 20, which is preferably a truncated cone.

In the preferred embodiment the loading body 20 is a set screw as shown in FIG. 11. The first end of the loading body 20 is preferably a truncated cone as depicted in FIG. 11. The cross port of claim one is threaded in the upper portion so that the loading body or set screw 20 can engage the cross port. The set screw is preferably torqued to at least 15 foot-pounds force, thus forcefully engaging the elongated looking body 10 under compressive load. The elongated looking body 10 thus places the conductive tube of coaxial cable 50 under compressive load. The foregoing describes the clamp invention used to retain a transmission line within a passageway. One such embodiment of the invention is a coaxial cable and a passageway within the tool end joints of a drill component.

Many types of data sources are important to management of a drilling operation. These include parameters such as hole temperature and pressure, salinity and pH of the drilling mud, magnetic declination and horizontal declination of the bottom-hole assembly, seismic look-ahead information about the surrounding formation, electrical resistivity of the formation, pore pressure of the formation, gamma ray characterization of the formation, and so forth. The high data rate provided by the present invention provides the opportunity for better use of this type of data and for the development of gathering and use of other types of data not presently available.

It is therefore intended that the foregoing detailed description be regarded as illustrative rather than limiting, and that it be understood that it is the following claims, including all equivalents, that are intended to define the spirit and scope of this invention.

1. A clamp to retain an electrical transmission line within a passageway the clamp comprising:
a cross port communicating with the passageway;
an elongate looking body having a first end, a second end, and an outer portion contained within the cross port, a portion of the first end adapted to engage an outer diameter of the electrical transmission line, the first end engaging the outer diameter of the electrical transmission line;
a loading body, the loading body comprising a first end, a second end, and an outer portion contained within the cross port, the outer portion adapted to engage the cross port, the outer portion engaging the cross port, the first end forcefully engaging the second end of the elongate looking body placing the elongate looking body under compressive load.

2. The elongate looking body of claim one wherein the first end forms a generally rounded surface.

3. The elongate looking body of claim one wherein the second end forms a generally rounded surface.

4. The elongate looking body of claim one wherein the portion of the first end adapted to engage the outer diameter of the electrical transmission line is a slot.

5. The elongate looking body of claim four wherein the slot has ridges on its surface.

6. The elongate looking body of claim one wherein the outer portion contains grooves adapted to house a sealing mechanism, the sealing mechanism forming a seal between the cross port and the elongate looking body.

7. The elongate looking body of claim six wherein the outer portion contains one or more circumferential o-ring grooves.

8. The elongate looking body of claim one is made of metal.

9. The elongate looking body of claim eight wherein the metal is selected from the group consisting of steel, titanium, chrome, nickel, aluminum, iron, copper, tin, and lead.

10. The elongate looking body of claim nine wherein the steel is selected from the group consisting of viscount 44, D2, stainless steel, tool steel, and 4100 series steels.

11. The elongate looking body of claim one is made of a ceramic.

12. The elongate looking body of claim eleven wherein the ceramic is selected from the group consisting of cemented tungsten carbide, alumina, silicon carbide, silicone nitride, and polycrystalline diamond

13. The elongate looking body of claim one has a hardness of least 30 on a Rockwell C hardness scale.

14. The elongate looking body of claim one is generally cylindrical.

15. The loading body of claim one is generally cylindrical.

16. The loading body of claim one wherein the outer portion is tapered.

17. The loading body of claim one wherein the first end is a truncated cone.

18. The loading body of claim one wherein the first end is generally round.

19. The loading body of claim one wherein the first end is concave.

20. The loading body of claim one is a set screw.

21. The cross port of claim one is generally cylindrical.

22. The cross port of claim one is generally tapered.

23. The cross port of claim one is adapted to engage the outer portion of the loading body of claim one.

24. The cross port of claim twenty-three has a threaded portion to engage a set screw.

25. A system for mechanically retaining a coaxial cable in a passageway comprising:
a coaxial cable, the coaxial cable comprising a conductive tube and a conductive core within it,
a cross port communicating with the passageway,
an elongate looking body having a first end, a second end, and an outer portion contained within the cross port, a portion of the first end adapted to engage the outer diameter of the conductive tube, the first end engaging the outer diameter of the conductive tube;
a loading body, the loading body comprising a first end, a second end, and an outer portion contained within the cross port, the outer portion engaging the cross port, the first end forcefully engaging the second end of the elongate looking body placing the elongate looking body under compressive load.

26. The system of claim twenty-five wherein the conductive tube has an elasticity such that the conductive tube is in tension.

27. The system of claim twenty-five wherein the loading body is torqued to at least 15 foot-pounds force.

28. A system for mechanically retaining a coaxial cable for use in a rotary drill string, the drill string comprising individual drill components, each drill component containing the coaxial cable; the system comprising:
a drill pipe with a uniform internal diameter having a box end tool joint and a pin end tool joint;
a first and second passageway in each pin end and box end tool joint which is connected to the internal pipe diameter and runs along the longitudinal axis of the pipe,
a first cross port disposed in the pin end tool joint and a second cross port disposed in the box end tool joint, each cross port in communication with the respective passageway in each pin and box end tool joint;
a coaxial cable, the coaxial cable comprising a conductive tube and a conductive core within it, the coaxial cable disposed in the passageway of each pin and box end tool joint, the coaxial cable running along the longitudinal axis of the pipe;
a first and second elongate looking body each having a first end, a second end, and an outer portion contained within the first and second cross ports, a portion of the first end adapted to engage the outer diameter of the conductive tube, the first end engaging the outer diameter of the conductive tube;
a first and second loading body, each loading body comprising a first end, a second end, and an outer portion contained within the first and second cross ports, the outer portion engaging the cross port, the first end forcefully engaging the second end of the elongate looking body placing the elongate looking body under compressive load.

29. The system of claim twenty-eight wherein the conductive tube has an elasticity such that the conductive tube is in tension.

30. The system of claim twenty-eight wherein the loading bodies are set screws

31. The system of claim twenty-eight wherein the set screws are torqued to at least 15 foot-pounds force.

32. The system in claim twenty-eight wherein the tube is tensioned between 300 and 1200 pounds force.

33. The system in claim twenty-eight wherein the first and second loading bodies' first end is a truncated cone.

34. The system in claim twenty-eight wherein the first and second cross ports have a threaded portion to accept a set screw.
